(19) United States
(12) Patent Application Publication
(10) Pub. No.: US 2017/0162133 A1
(43) Pub. Date: Jun. 8, 2017

(54) BACKLIGHT UNIT AND LIQUID CRYSTAL DISPLAY DEVICE

(71) Applicant: FUJIFILM Corporation, Tokyo (JP)

(72) Inventors: Megumi SEKIGUCHI, Kanagawa (JP); Makoto KAMO, Kanagawa (JP)

(73) Assignee: FUJIFILM Corporation, Tokyo (JP)

(21) Appl. No.: 15/434,727

(22) Filed: Feb. 16, 2017

Related U.S. Application Data
(63) Continuation of application No. PCT/JP2015/071265, filed on Jul. 27, 2015.

(30) Foreign Application Priority Data
Aug. 18, 2014 (JP) 2014-166261
Nov. 10, 2014 (JP) 2014-228351

(51) Int. Cl. G02F 1/1335

(52) U.S. Cl. CPC G09G 3/36

(57) ABSTRACT

An aspect of the present invention relates to a backlight unit, including: a polarized light source unit which is capable of allowing polarized light to exit; and a condensing sheet which is disposed on the polarized light source unit on an exiting side, in which a depolarization degree of the condensing sheet is less than or equal to 0.1500, and a liquid crystal display device, including: the backlight unit; and a liquid crystal panel.

### CROSS-REFERENCE TO RELATED APPLICATIONS

This application is a Continuation of PCT International. Application No. PCT/JP2015/071265 filed on Jul. 27, 2015, which claims priority under 35 U.S.C §119(a) to Japanese Patent Application No. 2014-166261 filed on Aug. 18, 2014 and Japanese Patent Application No. 2014-228351 filed on Nov. 10, 2014. Each of the above applications is hereby expressly incorporated by reference, in its entirety.

### BACKGROUND OF THE INVENTION

1. Field of the Invention

The present invention relates to a backlight unit and a liquid crystal display device.

2. Description of the Related Art

A liquid crystal display device (hereinafter, also referred to as a liquid crystal display (LCD)) has been widely used annually as a space saving image display device having low power consumption. In general, the liquid crystal display device is configured of a backlight unit and a liquid crystal panel, and the liquid crystal panel includes a member such as a pair of polarizing plates (a backlight side polarizing plate and a visible side polarizing plate) sandwiching a liquid crystal cell therebetween.

In order to increase a brightness (luminance) of a display surface of the liquid crystal display device, it is effective to increase an exiting amount of light from a light source. However, increasing the light source for increasing the luminance causes an increase in power consumption. Therefore, recently, it has been proposed that means for improving luminance by increasing a use efficiency of light exiting from the light source (hereinafter, also referred to as “luminance improvement means”) is disposed between the light source and the liquid crystal panel. In the specification of U.S. Pat. No. 7,777,832B, a light management unit including a reflective polarizer is disclosed as one of such means.

### SUMMARY OF THE INVENTION

The light management unit disclosed in the specification of U.S. Pat. No. 7,777,832B includes the reflective polarizer, a directionally recycling layer, and the like, and thus, improves luminance, but in order for further power saving of the backlight unit, it is desirable that the luminance is further improved by the luminance improve means.

Therefore, an object of the present invention is to provide a backlight unit including novel luminance improve means which can further improve luminance.

As a result of intensive studies of the present inventors for attaining the object described above, a backlight unit, comprising: a polarized light source unit which is capable of allowing polarized light to exit; and a condensing sheet which is disposed on the polarized light source unit on an exiting side, in which a depolarization degree of the condensing sheet is less than or equal to 0.1500, has been newly found, and thus, the present invention has been completed.

Here, the condensing sheet is a sheet having a condensing function, and in a liquid crystal display device which includes a backlight unit including the sheet, the sheet can exert an effect of increasing the amount of light incident on the display surface, compared to a case where the sheet is not included. Furthermore, the depolarization degree of the condensing sheet described above in a case where two or more condensing sheets are laminated indicates the depolarization degree of at least one condensing sheet, it is preferable that the number of condensing sheets of which the depolarization degree is less than or equal to 0.1500 increases, and it is more preferable that the depolarization degree of all condensing sheets is less than or equal to 0.1500.

The same applies to various physical properties of the condensing sheet, such as a visible light reflectivity, birefringence, and the like.

In addition, the depolarization degree described above indicates a value measured by the following method.

Two linear polarizing plates are arranged on a white light source such that transmission axes thereof are orthogonal to each other (crossed nicols arrangement), and the condensing sheet is disposed between the two linear polarizing plate. Here, the condensing sheet is disposed such that an incidence side of light incident from the polarized light source unit is positioned on an incidence side of light from the white light source described above in the backlight unit.

Then, in a state of being arranged as described above, the condensing sheet is rotated in the plane parallel to the linear polarizing plate, and luminance at an angle in which the luminance becomes the darkest (hereinafter, referred to as “Tcross”) is measured,

Next, the two linear polarizing plates are arranged such that transmission axes thereof are parallel to each other (parallel nicols arrangement), and luminance in this state (hereinafter, referred to as “Tpara”) is measured.

From the measured luminance Tcross and Tpara, a depolarization degree depolarization index (DI) is calculated by Expression I described below. The measurement can be referred to the description of Yuka Utsunmi et al., EuropDisplay 2005, p 302, 3.1 Experiments.

$$DI = \frac{2}{1 + \frac{{T}_{para}}{{T}_{cross}}} \qquad ( Expression I )$$

In the aspect, a visible light reflectivity measured on a surface of the condensing sheet on the polarized light source unit side is less than or equal to 70%.

The visible light reflectivity described above indicates a value measured by the following method.

In the backlight unit of the condensing sheet, the surface disposed on the polarized light source unit side is irradiated with visible light at each 10 degrees from 0 degrees (a normal direction) in a range of -80 degrees to 80 degrees, and light intensity of transmitted light which has been transmitted through the condensing sheet is measured by using a goniophotometer. A visible light transmittance TI is obtained as a value which is obtained by dividing an integrating accumulated value obtained by integrating accumulating the light intensity at each incidence angle by the total amount of light without the condensing sheet, and a visible light reflectivity (Unit: %) is obtained as (1−T)×100.

In the aspect, the polarized light source unit includes at least a light source and a reflective polarizer. The reflective polarizer indicates a polarizer having a function of reflecting light in a first polarization state and of transmitting light in a second polarization state among incidence rays.

Regarding this, in general, a polarizer disposed on a liquid crystal panel (a visible side polarizer and a backlight side polarizer) is a polarizer fir turning on and off light which is transmitted through a liquid crystal cell, and is a polarizer (an absorptive polarizer) having properties of absorbing light which is not transmitted through the liquid crystal cell. Hereinafter, unless otherwise particularly stated, the polarizer indicates the absorptive polarizer.

In addition, the polarizing plate indicates a member which includes a reflective polarizer or an absorptive polarizer, and can further include other constituents such as a protective film. Unless otherwise particularly stated, the polarizing plate indicates a polarizing plate including the absorptive polarizer. The linear polarizing plate described above indicates a polarizing plate including a polarizer (a linear polarizer) which allows linearly polarized light to exit. In contrast, a polarizer which allows circularly polarized light to exit will be referred to as a circular polarizer, and a polarizing plate including the circular polarizer will be referred to as a circularly polarizing plate.

In the aspect, the polarized light source unit includes a quantum dot-containing layer between the light source and the reflective polarizer.

In the aspect, the light source is a blue light source, and the quantum dot-containing layer contains a quantum dot which is excited by exciting light and emits red light and a quantum dot which is excited by exciting light and emits green light.

In the aspect, a selective reflective layer having a reflective center wavelength in a wavelength range of blue light is included between the quantum dot-containing layer and the reflective polarizer.

In the aspect, a selective reflective layer having a reflective center wavelength in a wavelength range of green light and in a wavelength range of red light is included between the light source and the quantum dot-containing layer.

In the aspect, the polarized light source unit includes at least a light source and a quantum rod-containing layer.

In the aspect, the light source is a blue light source, the quantum rod-containing layer contains a quantum rod which is excited by exciting light and emits red polarized light and a quantum rod which is excited by exciting light and emits green polarized light, and a selective reflective polarizer having a reflective center wavelength in a wavelength range of blue light is further included between the quantum rod-containing layer and the condensing sheet.

In the aspect, a selective reflective polarizer having a reflective center wavelength in a wavelength range of green light and in a wavelength range of red light is included between the light source and the quantum rod-containing layer.

In the aspect, the condensing sheet includes a plurality of convex portions on a surface on the exiting side.

In the aspect, a sectional shape of the convex portion is a curved surface shape.

In the aspect, the condensing sheet is a laminated sheet of two or more layers, and includes a plurality of convex portions protruding to the exiting side on an interface between two layers.

In the aspect, a sectional shape of the convex portion is a curved surface shape.

In the aspect, the condensing sheet is a gradient index (or graded index (GRIN)) rod lens array sheet.

In the aspect, the GRIN rod lens is a cylinder lens.

Another aspect of the present invention relates to a liquid crystal display device, comprising: the backlight unit described above; and a liquid crystal panel.

According to the present invention, it is possible to provide a backlight unit which can improve luminance, and a liquid crystal display device including the backlight unit.

### BRIEF DESCRIPTION OF THE DRAWINGS

FIG. 1 illustrates an example of a liquid crystal display device according to an aspect of the present invention.

### DESCRIPTION OF THE PREFERRED EMBODIMENTS

The following description is based on representative embodiments of the present invention, but the present invention is not limited to the embodiments. Furthermore, in the present invention and herein, a numerical range represented by using “to” indicates a range including numerical values before and after “to” as the lower limit value and the upper limit value.

In addition, in the present invention and herein, a “half-width” of a peak indicates the width of a peak at a height of ½ of a peak height. Visible light indicates light in a wavelength range of 380 to 780 nm. Ultraviolet light indicates light in a wavelength range of 300 nm to 430 nm.

In addition, light having a light emission center wavelength in a wavelength range of 400 to 500 nm, and preferably in a wavelength range of 430 to 480 nm will be referred to as blue light, light having a light emission center wavelength in a wavelength range of 500 to 600 nm will be referred to as green light, and light having a light emission center wavelength in a wavelength range of 600 to 680 nm will be referred to as red light. Furthermore, the wavelength range described above in which the light emission center wavelength of the blue light exists will be referred to as a wavelength range of blue light. The same applies to a wavelength range of green light and a wavelength range of red light.

In addition, in the present invention and herein, an angle (for example, an angle such as “90°”), and a relationship thereof (for example “orthogonal”, “parallel”, and the like) include an error range which is allowable in the technology field to which the present invention belongs. For example, the angle indicates a range of less than an exact angle ±10°, and an error with respect to the exact angle is preferably less than or equal to 5°, and is more preferably less than or equal to 3°.

[Backlight Unit]

An aspect of the present invention relates to a backlight unit including a polarized light source unit which is capable of allowing polarized light to exit, and a condensing sheet which is disposed on the polarized light source unit on an exiting side, in which a depolarization degree of the condensing sheet is less than or equal to 0.1500.

The following description does not limit the present invention, and the present inventors have considered the reason that luminance of a liquid crystal display device including the backlight unit can be improved by the backlight unit described above as follows.

A backlight side polarizer (an absorptive polarizer) of a liquid crystal panel transmits light in a specific polarization state and absorbs light which is not transmitted among incidence rays. In a case where light to be absorbed can be reduced, it is possible to increase a use efficiency of light exiting from the backlight unit and to improve luminance.

Regarding this viewpoint, the light management unit described in the specification of U.S. Pat. No. 7,777,832B described above includes the reflective polarizer. In a case where light exiting from the light source of the backlight unit is incident on the reflective polarizer, the light in the specific polarization state (polarized light which can be transmitted through the backlight side polarizer) exits from the reflective polarizer, and light in the other polarization state is reflected. A phenomenon is repeated in which the reflected light is reflected by a reflective member (a reflective plate or the like) included in the backlight unit, and is incident again on the reflective polarizer, and then, a number of light rays become the light in the specific polarization state and exit from the reflective polarizer. Accordingly, it is possible to reduce the light to be absorbed by the backlight side polarizer. Furthermore, the present inventors have considered this viewpoint, and have found that insofar as polarized light can exit from the backlight unit, it is possible to attain improvement in luminance by the same effect as that described above even in a ease of using means other than the reflective polarizer. The details thereof will be described below.

However, the light management unit described in the specification of U.S. Pat. No. 7,777,832B includes the directionally recycling layer on the reflective polarizer on the exiting side. The directionally recycling layer can function as a condensing sheet, but the present inventors have further considered that whether or not the condensing sheet (the directionally recycling layer) inhibits further improvement in the luminance. As a result thereof, it has been newly found that it is possible to further improve the luminance by decreasing the depolarization degree of the condensing sheet through which the polarized light exiting from the reflective polarizer or the like is transmitted before being incident on the liquid crystal panel. The present inventors have considered that this is because of the following reasons. The depolarization degree of a certain member is an index of the degree of the polarized light incident on the member which exits while maintaining a polarization state, and the details of a measurement method are as described, above. As the numerical value becomes smaller, the proportion of the polarized light exiting while maintaining the polarization state increases, and as the numerical value becomes larger, the proportion of the polarized light exiting by being depolarized increases. In a case where the polarized light exiting from the reflective polarizer or the like is incident on a condensing sheet having a high depolarization degree, the polarized light is incident on the backlight side polarizer of the liquid crystal panel and is absorbed in a state where a number of polarized light rays are depolarized. Accordingly, a use efficiency of light decreases, whereas according to a condensing sheet having a low depolarization degree, it is possible to reduce a loss in the polarized light due to depolarization, and thus, it is possible to prevent a decrease in the use efficiency of the light due to the absorption of the backlight side polarizer. Accordingly, the present inventors have assumed that it is possible to further improve the luminance by the backlight unit described above.

Here, the above description includes the assumption of the present inventors, and does not limit the present invention.

Hereinafter, the backlight unit described above will be described in more detail.

<1. Configuration of Backlight Unit>

The configuration of the backlight unit includes at least a light source and a light guide plate, and includes an edge light mode backlight unit arbitrarily including a reflective plate, a diffusion plate, and the like, and a direct backlight mode backlight unit including at least a reflective plate, a plurality of light sources disposed on the reflective plate, and a diffusion plate. The backlight unit described above may have any configuration. The details thereof are described in each publication of JP3416302B, JP3363565B, JP4091978B, JP3448626B, and the like, and the contents of the publications are incorporated in the present invention.

<2. Condensing Sheet>

(2-1. Depolarization Degree of Condensing Sheet)

The condensing sheet included in the backlight unit described above can condense light exiting from the polarized light source unit. Further, the condensing sheet is a sheet of which the depolarization degree is less than or equal to 0.1500, and thus, can allow a number of polarized light rays incident from the polarized light source unit to exit while maintaining the polarization state. Accordingly, as described above, it is possible to prevent a decrease in a use efficiency of light due to the absorption of the backlight side polarizer of the liquid crystal panel. Thus, in the liquid crystal display device including the backlight unit described above, it is possible to display an image having a high luminance on a display surface.

The depolarization degree of the condensing sheet described above is less than or equal to 0.1500, is preferably less than or equal to 0.1000, is more preferably less than or equal to 0.0100, and is even more preferably less than or equal to 0.0050. The depolarization degree described above, for example, is greater than or equal to 0.0001, it is preferable that the depolarization degree becomes lower from the viewpoint of attaining improvement in luminance by increasing a use efficiency of light, and it is most preferable that the depolarization degree is 0.

(2-2. Visible Light Reflectivity of Condensing Sheet)

It is preferable that a visible light reflectivity of the condensing sheet is low, and light which is reflected by the condensing sheet and returns to the polarized light source side decreases among the light exiting from the polarized light source unit from the viewpoint of further improving the luminance. From this viewpoint, a visible light transmittance measured on the surface of the condensing sheet described above on the polarized light source unit side is preferably less than or equal to 70%, is more preferably less than or equal to 60%, is even more preferably less than or equal to 50%, and is still more preferably less than or equal to 40%. The visible light reflectivity described above, for example, is greater than or equal to 20%, and it is preferable that the visible light reflectivity becomes lower, and thus, the lower limit value is not particularly limited.

(2-3. Configuration of Condensing Sheet)

The depolarization degree and the visible light transmittance of the condensing sheet can be controlled according to the thickness of the condensing sheet, a material for preparing the condensing sheet, a surface shape of the condensing sheet (preferably, a surface shape on the exiting side), an interface shape of two layers in a case where the condensing sheet is a laminated sheet of two or more layers, and the like.

The thickness of the condensing sheet is preferably less than or equal to 180 μm, and is more preferably less than or equal to 90 μm. In addition, the thickness of the condensing sheet, for example, is greater than or equal to 20 μm. Furthermore, in a condensing sheet having different thickness in each portion, such as a condensing sheet having a convex portion on a surface on the exiting side described below, the thickness of the thickest portion in a thickness direction is set to the thickness of the condensing sheet.

A material having low birefringence, specifically, having low retardation Re in an in-plane direction is preferably used as the material. Examples of such a material can include cellulose acylate, a (meth)acrylic resin, a cyclic polyolefin resin (a resin having a cyclic olefin structure), and the like. For example, it is possible to prepare the condensing sheet of which the depolarization degree is less than or equal to 0.1500 by using a single layer sheet of the resin described above or by using a sheet of the resin described above as a base sheet. A commercially available product can be used as the resin described above, or the resin described above can be synthesized by a known method.

Herein, Re(λ) indicates in-plane retardation at a wavelength of λ nm. Herein, unless otherwise particularly stated, the wavelength of λ nm is 550 nm. Re(λ) is measured by allowing light at the wavelength of λ nm to be incident on KOBRA 21ADH (manufactured by Oji Scientific Instruments) in a film normal direction. In selection of a measurement wavelength of λ nm, measurement can be performed by manually exchanging a wavelength selective filter or by converting a measurement value using a program or the like. In the retardation Re of the condensing sheet, an absolute value is preferably from 0 nm to 30 nm, and the absolute value is more preferably from 0 nm to 20 nm, with respect to light at a wavelength of 550 nm. The retardation Re of the condensing sheet may be measured by disposing the condensing sheet such that an incidence side of light which is incident from the polarized light source unit is positioned on an incidence side of light to be used in the measurement in the backlight unit, or may be measured by disposing the condensing sheet vice versa. In addition, in a case where light is condensed and is spread due to concavities and convexities on the surface, and thus, it is difficult to measure the retardation Re, the measurement may be performed by filling the concavities and convexities with a resin (a (meth)acrylic resin, a cyclic polyolefin resin, and the like) which has retardation Re of zero and has a refractive index close to that of a substance of a measurement target.

In one aspect, the condensing sheet can include a plurality of convex portions on the surface on the exiting side. Examples of a surface shape of such a surface on the exiting side can include a surface shape of a prism sheet and a micro lens array. That is, in one aspect, the condensing sheet can be a prism sheet or a micro lens array sheet. Such a condensing sheet includes the convex portion, and thus, can exert an excellent condensing effect.

Specific examples of the surface shape can include a concave and convex shape which is formed by two-dimensionally arranging shapes selected from the group consisting of a polygonal pyramidal shape, a conical shape, a partially rotational ellipsoidal shape, and a partially spherical shape.

In addition, in another aspect, specific examples of the surface shape can include a concave and convex shape which is formed by one-dimensionally arranging shapes selected from the group consisting of a partially cylindrical shape, a partially elliptic cylinder shape, and a prismatic shape.

Here, the “polygonal pyramidal shape” is used as the meaning including not only a perfect polygonal pyramidal shape, but also a shape similar to a polygonal pyramid. The same applies to the other shapes described above.

In addition, being one-dimensionally arranged indicates that the shapes described above are arranged in only one direction of the surface of the condensing sheet on the exiting side, that is, are arranged in parallel. Such a concave and convex shape will be also referred to as a line and space pattern. In a condensing sheet having concave and convex shapes which are one-dimensionally arranged, it is preferable that two condensing sheets are laminated such that line and space patterns of both condensing sheets are orthogonal to each other. Accordingly, it is possible to increase a condensing effect.

On the other hand, being two-dimensionally arranged indicates that the shapes described above are arranged in two or more directions of the surface of the condensing sheet on the exiting side. For example, being two-dimensionally arranged includes not only an aspect in which the shapes are formed in two directions of a certain direction, and a direction orthogonal to the certain direction or the shapes are regularly formed, but also an aspect in which the shapes are irregularly (randomly) formed.

It is preferable that the sectional shape of the convex portion described above is a curved surface shape from the viewpoint of attaining further improvement in luminance by decreasing the visible light reflectivity described above. This is because the visible light reflectivity tends to increase by including a corner portion in the sectional shape of the convex portion. It is preferable that the sectional shape of the convex portion does not include a corner portion of which an apex angle is 70 degrees to 90 degrees from the viewpoint of reducing the visible light reflectivity.

Examples of the condensing sheet including the convex portion of which the sectional shape is the curved surface shape can include a micro lens array sheet. A micro lens array sheet in which shapes selected from the group consisting of a partially cylindrical shape and a partially elliptic cylinder shape are one-dimensionally arranged and a micro lens array sheet in which shapes selected from the group consisting of a partially rotational ellipsoidal shape and a partially spherical shape are two-dimensionally arranged are more preferable, and the latter micro lens array sheet is even more preferable.

In addition, an aspect of the condensing sheet is a laminated sheet of two or more layers, and can include a condensing sheet which includes a convex portion protruding to the exiting side on an interface between two layers. The shape of the interface described above is as described in the surface on the exiting side including the convex portion described above. Furthermore, in the condensing sheet which is such a laminated sheet, the surface on the exiting side may be a flat surface, or may include the convex portion as described above. In the laminated sheet, it is preferable that a layer disposed on the exiting side is a layer having a refractive index lower than that of a layer adjacent to the layer on the incidence side. This is because in a case where light is incident on a laminated sheet in which a layer having a high refractive index (a layer of high refractive index) and a layer having a low refractive index (a layer of low refractive index) are disposed in this order from the incidence side towards the exiting side, the light is condensed to the exiting side on an interface between the layer of high refractive index and the layer of low refractive index, and thus, it is possible to obtain a condensing effect. Furthermore, in the present invention and herein, the refractive index indicates a refractive index nd with respect to a d-line of FRAUNHOFER. In a laminated sheet of three or more layers, it is preferable that a layer which is positioned closest to the exiting side is the layer of low refractive index, and a layer adjacent to the layer is the layer of high refractive index. Other layers may be a layer having a refractive index lower than that of the adjacent layer, or may be a layer having a refractive index higher than that of the adjacent layer. A preferred specific aspect, for example, can include a laminated sheet in which three layers of a first layer of low refractive index, a layer of high refractive index having a refractive index higher than that of the first layer of low refractive index, and a second layer of low refractive index having a refractive index lower than that of the layer of high refractive index are laminated in this order from the incidence side towards the exiting side. In this aspect, it is possible to obtain the condensing effect described above along with an effect of reducing the depolarization degree.

In addition, in one aspect, a condensing sheet can be used in which the layer of high refractive index and the layer of low refractive index are adjacent to each other in this order from the incidence side towards the exiting side, and the interface between the layer of high refractive index and the layer of low refractive index is a flat surface. It is preferable that the convex portion described above exists on the interface from the viewpoint of a condensing effect.

Another aspect of the condensing sheet can include a gradient index rod lens array sheet. The gradient index (GRIN) rod lens is a rod (cylindrical) lens, and indicates a lens of which a refractive index in the lens is uneven. Light is incident on an array sheet in which a plurality of GRIN rod lenses are arranged (embedded) from one end surface side of the GRIN rod lens, and thus, it is possible to obtain a condensing effect. It is preferable that the refractive index continuously or intermittently decreases from a center portion of the rod lens towards an outer circumferential portion, from the viewpoint of a condensing effect. In addition, the GRIN rod lens array sheet, in general, is a sheet in which a plurality of rod lenses are embedded in a matrix. It is preferable that the refractive index of the matrix surrounding the rod lens is identical to or lower than the refractive index of the outer circumferential portion of the rod lens. The shape of the rod lens can be an arbitrary shape such as a cylinder shape and a prismatic shape. It is preferable that the GRIN rod lens is a cylinder lens from the viewpoint of a condensing effect.

A known technology can be applied to the details of the shape, a preparation method, or the like of the condensing sheet having various shapes described above. For example, the micro lens array sheet can be referred to paragraphs 0010 to 0035 of JP2008-226763A, paragraphs 0014 to 0020 of JP2007-079208A, paragraphs 0011 to 0075 of JP2010-115804A, and paragraphs 0017 to 0035 of JP2011-134609A, and the GRIN rod lens array sheet can be referred to paragraphs 0005 to 0008 of JP2013-541738A and paragraphs 0005 to 0017 of JP2007-34046A.

Furthermore, the depolarization degree and the visible light transmittance can be controlled according to the height and the width of the convex portion, a distance (a pitch) between the convex portions, the size of the GRIN rod lens (a diameter, a length, and the like), a distance (a pitch) between the GRIN rod lenses, and the like.

<3. Polarized Light Source. Unit>

Next, the polarized light source unit will be described.

The polarized light source unit may be a light source unit which is capable of allowing polarized light to exit to at least the condensing sheet side. An aspect can include a polarized light source unit (hereinafter, referred to as a “polarized light source unit A”) including at least a light source and a reflective polarizer. Another aspect can include a polarized light source unit (hereinafter, referred to as a “polarized light source unit B”) including at least a light source and a quantum rod-containing layer. Furthermore, both of the polarized light source units A and B can include various members which are included in a general backlight unit, such as a light guide plate, a reflective plate, and a diffusion plate. The members are not particularly limited, and for example, can be referred to each publication or the like described above.

Hereinafter, the polarized light source units A and B will be sequentially described.

(3-1. Polarized Light Source Unit A: Aspect Including Reflective Polarizer)

(3-1-1. Light Source)

In one aspect, a light source included in the polarized light source unit A is a white light source. The white light source is a light source emitting white light by including a plurality of light emitting elements emitting light having a light emission center wavelength in a different wavelength range. Examples of the white light source can include a light source emitting white light by including a light emitting element emitting blue light and a light emitting element emitting yellow light (light having a light emission center wavelength in a wavelength range of 570 to 585 nm), but are not limited thereto. A light emitting diode (LED) is preferable as the light emitting element, and the light emitting element can be substituted with a laser light source. The same applies to an aspect described below.

(3-1-2. Quantum Dot-Containing Layer)

In another aspect, the polarized light source unit A can include the quantum dot-containing layer along with the light source. A quantum dot (QD, also referred to as a quantum point) is a fluorescent body having a discrete energy level due to a quantum confinement effect. A quantum rod described below is excited by exciting light and emits polarized light, whereas the quantum dot is excited by exciting light and emits fluorescent light not having polarization properties (also referred to as omni-directional light and non-polarized light). The quantum dot, for example, contains semiconductor crystal (semiconductor nano crystal) particles having a nano order size, particles of which the semiconductor nano crystal surfaces are modified by an organic ligand, or particles of which the semiconductor nano crystal surfaces are covered with a polymer layer. The light emission wavelength of the quantum dot, in general, can be adjusted according to the composition of the particles, the size of the particles, and the composition and the size. The quantum dot can be synthesized by a known method, and is available as a commercially available product. The details thereof, for example, can be referred to US2010/123155A1, JP2012-509604A, U.S. Pat. No. 8,425,803B, JP2013-136754A, WO2005/022120A, JP2006-521278A, JP2010-535262A, JP2010-540709A, and the like.

In, a case where a blue light source emitting blue light is used as the light source, it is preferable that a quantum dot layer contains a quantum dot which is excited by exciting light and emits red light, and a quantum dot which is excited by exciting light and emits green light. The quantum dots can be excited by the blue light from the blue light source or by fluorescent light emitted from the quantum dot excited by the blue light (internal light emission), and can emit each colored light described above. Accordingly, it is possible to obtain white light by the blue light which is emitted from the light source and is transmitted through the quantum dot-containing layer, and the red light and the green light which are emitted from the quantum dot-containing layer.

Alternatively, in still another aspect, it is possible to use an ultraviolet light source emitting ultraviolet light. In this case, it is preferable that the quantum dot layer contains a quantum dot which is excited by exciting light and emits blue light in addition to the quantum dot which is excited by exciting light and emits red light and the quantum dot emitting green light. It is possible to obtain white light by the blue light, the red light, and the green light emitted from the quantum dots having different light emitting properties which are excited by the ultraviolet light from the ultraviolet light source or by fluorescent light emitted from the quantum dot excited by the ultraviolet light (internal light emission).

In order to allow the white light obtained by using the quantum dot-containing layer as described above to be incident on the reflective polarizer, it is preferable that the quantum dot-containing layer is disposed between the light source and the reflective polarizer.

The blue light source described above is a light source emitting light having a single peak. Here, emitting light having a single peak indicates not that two or more peaks appear in a light emission spectrum as the white light source, but that only one peak of maximizing light emission of a light emission center wavelength exists. In addition, the fluorescent body such as the quantum dot and the quantum rod described below can emit fluorescent light having a single peak of maximizing light emission of a light emission center wavelength. By setting monochromatic light having such a single peak to have mixed color, it is possible to embody white light. In addition, among fluorescent bodies, the quantum dot and the quantum rod described below are preferred fluorescent bodies, from the viewpoint of emitting fluorescent light having a narrow half-width and from the viewpoint of improving luminance and of increasing a color reproduction range. The half-width of the fluorescent light emitted from the quantum dot and the quantum rod described below is preferably less than or equal to 100 nm, is more preferably less than or equal to 80 nm, is even more preferably less than or equal to 50 nm, is still more preferably less than or equal to 45 nm, and is even still more preferably less than or equal to 40 nm.

In general, the quantum dot-containing layer contains the quantum dot in a matrix. In general, the matrix is a polymer (an organic matrix) in which a polymerizable composition is polymerized by light irradiation or the like. The quantum dot-containing layer can be prepared by a preferred coating method. Specifically, a polymerizable composition (a curable composition) containing a quantum dot is applied onto a suitable base, and then, is subjected to a curing treatment by light irradiation or the like, and thus, it is possible to obtain the quantum dot-containing layer.

The quantum dot may be added to a polymerizable composition (a coating liquid) for forming the quantum dot-containing layer in a state of particles, or may be added in a state of a dispersion liquid in which the quantum dots are dispersed in a solvent. Being added in the state of the dispersion liquid is preferable from the viewpoint of suppressing aggregation of the quantum dots. Here, the solvent to be used is not particularly limited. For example, approximately 0.01 to 10 parts by mass of the quantum dot can be added with respect to 100 parts by mass of the total amount of coating liquid described above.

A polymerizable compound used for preparing the polymerizable composition is not particularly limited. Only one type of the polymerizable compound may be used, or two or more type thereof may be used by being mixed. It is preferable that the content of the total polymerizable compound in the total amount of the polymerizable composition is approximately 10 to 99.99 mass %. Examples of a preferred polymerizable compound can include a monofunctional (meth)acrylate compound or a polyfunctional (meth)acrylate compound such as a monofunctional (meth)acrylate monomer or a polyfunctional (meth)acrylate monomer, and a polymer and a prepolymer thereof from the viewpoint of transparency, adhesiveness, and the like of a cured film after being cured. Furthermore, in the present invention and herein, “(meth)acrylate” is used as the meaning including at least one of acrylate or methacrylate or any one of acrylate and methacrylate. The same applies to “(meth)acryloyl” or the like.

Examples of the monofunctional (meth)acrylate monomer can include an acrylic acid and a methacrylic acid, and a derivative thereof, and more specifically, a monomer having one polymerizable unsaturated bond of a (meth)acrylic acid (one (meth)acryloyl group) in the molecules. Specific examples thereof can be referred to paragraph 0022 of WO2012/077807A1.

A polyfunctional (meth)acrylate monomer having two or more (meth)acryloyl groups in the molecules can be used along with a monomer having one polymerizable unsaturated bond of the (meth)acrylic acid (one (meth)acryloyl group) in one molecule. The details thereof can be referred to paragraph 0024 of WO2012/077807A1. In addition, a polyfunctional (meth)acrylate compound described in paragraphs 0023 to 0036 of JP2013-043382A can be used as the polyfunctional (meth)acrylate compound. Further, an alkyl chain-containing (meth)acrylate monomer represented by General Formulas (4) to (6) described in paragraphs 0014 to 0017 of the specification of JP5129458B can also be used.

The use amount of the polyfunctional (meth)acrylate monomer is preferably greater than or equal to 5 parts by mass, from the viewpoint of strength of a coated film, and is preferably less than or equal to 95 parts by mass from the viewpoint of suppressing gelation of the composition, with respect to 100 parts by mass of the total amount of the polymerizable compound contained in the polymerizable composition. In addition, from the same viewpoint, the use amount of the monofunctional (meth)acrylate monomer is preferably from 5 parts by mass to 95 parts by mass with respect to 100 parts by mass of the total amount of the polymerizable compound contained in the polymerizable composition.

Examples of a preferred polymerizable compound can also include a compound having a cyclic group, for example, a cyclic ether group such as an epoxy group and an oxetanyl group, which can be subjected to ring opening polymerization. Examples of the compound can more preferably include a compound including a compound having an epoxy group (an epoxy compound). The epoxy compound can be referred to paragraphs 0029 to 0033 of JP2011-159924A.

The polymerizable composition described above can contain a known radical polymerization initiator or a known cationic polymerization initiator as a polymerization initiator. The polymerization initiator, for example, can be referred to paragraph 0037 of JP2013-043382A and paragraphs 0040 to 0042 of JP2011-159924A. The polymerization initiator is preferably greater than or equal to 0.1 mol %, and is more preferably 0.5 to 5 mol % with respect to the total amount of the polymerizable compound contained in the polymerizable composition.

A form method of the quantum dot-containing layer is not particularly limited insofar as the quantum dot-containing layer is a layer containing the components described above and an arbitrarily addible known additive. A composition prepared by simultaneously or sequentially mixing the components described above and one or more types of known additives which are added as necessary is applied onto a suitable base, and then, is polymerized and cured by being subjected to a polymerization treatment such as light irradiation and heating, and thus, it is possible to form the quantum dot-containing layer containing a quantum dot in a matrix. In addition, as necessary, a solvent may be added for the viscosity or the like of the composition. In this case, the type and the added amount of the solvent to be used are not particularly limited. For example, only one type of organic solvent can be used as the solvent or two or more types thereof may be used by being mixed.

The polymerizable composition described above is applied onto a suitable base, and as necessary, the solvent is removed by being dried, and after that, the polymerizable composition is polymerized and cured by light irradiation or the like, and thus, it is possible to obtain the quantum dot-containing layer. Examples of a coating method include a known coating method such as a curtain coating method, a dip coating method, a spin coating method, a printing coating method, a spray coating method, a slot coating method, a roll coating method, a slide coating method, a blade coating method, a gravure coating method, and a wire bar method. In addition, curing conditions can be suitably set according to the type of polymerizable compound to be used or the composition of the polymerizable composition.

The total thickness of the quantum dot-containing layer is preferably in a range of 1 to 500 μm, and is more preferably in a range of 100 to 400 μm. In addition, the quantum dot-containing layer may have a laminated structure in which quantum dots having two or more types of different light emitting properties are contained in different layers, or may contain quantum dots having two or more types of different light emitting properties in the same layer. In a case where the quantum dot-containing layer is a laminate of two or more layers of a plurality of layer, a film thickness of one layer is preferably in a range of 1 to 300 μm, is more preferably in a range of 10 to 250 μm, and is even more preferably in a range of 30 to 150 μm.

The quantum dot-containing layer can be included in the polarized light source unit A as it is or can be included in the polarized light source unit A as a laminate (a quantum dot sheet) in which the quantum dot-containing layer is laminated with one or more other members such as a support and a barrier film.

Furthermore, in one aspect, the polarized light source unit A can include a layer containing a fluorescent body other than a quantum dot, instead of the quantum dot-containing layer. In this aspect, the above description can be applied except that the fluorescent body is not the quantum dot.

(3-1-3. Reflective Polarizer)

Any reflective polarizer can be used as the reflective polarizer without any limitation insofar as the reflective polarizer has a function as the reflective polarizer described above.

An aspect of the reflective polarizer can include a multilayer film in which a plurality of layers having different refractive indices are laminated. By laminating the plurality of layers in a combination in which an interlaminar refractive index difference has an in-plane anisotropy, it is possible to obtain the multilayer film having a function as a reflective polarizer.

A layer configuring the multilayer film may be an inorganic layer, or may be an organic layer. For example, a dielectric multilayer film configured by sequentially laminating materials having different refractive indices (a high refractive index material and a low refractive index material) can be preferably used. Further, metal/dielectric multilayer film may be used in which a metal film is added to the layer configuration of the dielectric multilayer film. Furthermore, the multilayer film described above can be formed by stacking a plurality of film formation materials on a base by a known film formation method such as electron beam (EB) vapor deposition (electron beam co-vapor deposition) and sputtering. In addition, a multilayer film including an organic layer can be formed by a known film formation method such as coating and laminating. For example, a stretched film can be used as the organic layer. For example, a commercially available product such as APF and DBEF (Registered Trademarks, manufactured by Sumitomo 3M Limited) may he used as a multilayer film of the stretched film.

Examples of the dielectric multilayer film can include a layer having a configuration in which a titanium dioxide (TiO₂) layer and a silicon dioxide (SiO₂) layer are alternately laminated. In addition, dielectric body such as MgF₂, Al₂O₃, MgO, ZrO₂, Nb₂O₅, or Ta₂O₅ can also be used as a dielectric body. In addition, the configuration of the multilayer film can be referred to the description relevant to the multilayer film described in each specification of JP3187821B, JP3704364B, JP4037835B, JP4091978B, JP3709402B, JP4860729B, and JP3448626B.

In addition, a wire grid type polarizer which is a reflective polarizer allowing linearly polarized light to exit can also be used as the reflective polarizer. The wire grid polarizer is a reflective polarizer (a wire grid type polarizer) which transmits one polarized light ray according to birefringence of a metal thin wire, and reflects the other polarized light ray. The wire grid type polarizer is obtained by periodically arranging metal wires at regular intervals, and is mainly used as a polarizer in a terahertz wave range. By sufficiently decreasing the wire interval to be shorter than a wavelength of an incident electromagnetic wave, it is possible to allow the wire grid to function as a polarizer. A polarization component in a polarization direction parallel to a longitudinal direction of the metal wire is reflected on the wire grid polarizer, and a polarization component in a polarization direction perpendicular to the longitudinal direction of the metal wire is transmitted through the wire grid polarizer. The wire grid type polarizer is available as a commercially available product. Examples of the commercially available product include a wire grid polarization filter 50×50, NT46-636, manufactured by Edmund Optics Inc., and the like.

In addition, another aspect of the reflective polarizer can include a reflective polarizer allowing circularly polarized light to exit. A cholesteric liquid crystal layer can be used as such a reflective polarizer. The details thereof can be referred to the specification of EP606940A2, JP1996-271731A (JP-H08-271731A), and the like. Furthermore, in a case where a polarizer (a circular polarizer) allowing circularly polarized light to exit is used as the reflective polarizer, a λ/4 plate is disposed between the circular polarizer and the liquid crystal panel, and thus, it is possible to convert right circularly polarized light or left circularly polarized light exiting from the circular polarizer to linearly polarized light and to allow the converted linearly polarized light to be incident on the backlight side polarizer of the liquid crystal panel. A known λ/4 plate can be used as such a λ/4 plate.

The reflective polarizer can be used as it is, or may be used as a reflective polarizing plate in which other layers such as a protective film is laminated.

(3-1-4. Selective Reflective Layer and Selective Reflective Polarizer)

The polarized light source unit A can include a selective reflective layer which selectively reflects light in a certain wavelength range. For example, a selective reflective polarizer which selectively exerts a function as a reflective polarizer with respect to light in a certain wavelength range can be used as such a selective reflective layer. Here, the selective reflective layer is not limited to the selective reflective layer having a function as a reflective polarizer. For example, by laminating a plurality of layers in a combination in which an interlaminar refractive index difference does not have in-plane anisotropy, it is possible to prepare a selective reflective layer which does not function as a reflective polarizer (does not have polarization selectivity). Alternatively, by laminating a cholesteric liquid crystal layer which transmits one of right circularly polarized light and left circularly polarized light and reflects the other and a cholesteric liquid crystal layer having opposite transmission and reflection properties, it is possible to prepare a selective reflective layer not having polarization selectivity.

For example, in a case where the selective reflective layer or the selective reflective polarizer is prepared as the multilayer film, and a wavelength range to be reflected is determined, the layer configuration (a combination of film formation materials, and a film thickness of each layer) of the multilayer film which selectively reflects light in such a wavelength range can be determined according to a known film design method. In addition, in a case where the selective reflective layer or the selective reflective polarizer is prepared by using a cholesteric liquid crystal layer, a wavelength applying a peak (that is, a reflective center wavelength) can be adjusted by changing the pitch or the refractive index of the cholesteric liquid crystal layer. For example, the pitch can be easily adjusted by changing the added amount of a chiral agent. The details thereof are described in pp. 60 to 63 of Fuji Film research & development No. 50 (2005).

Examples of such a selective reflective polarizer can include a selective reflective layer having a reflective center wavelength in a wavelength range of blue light (hereinafter, also referred to as a “blue light selective reflective layer”, and a selective reflective layer which functions as a reflective polarizer will be also referred to as a “blue light selective reflective polarizer”), a selective reflective layer having a reflective center wavelength in a wavelength range of green light (hereinafter, also referred to as a “green light selective reflective layer”, and a selective reflective layer which functions as a reflective polarizer will he also referred to as a “green light selective reflective polarizer”), a selective reflective layer having a reflective center wavelength in a wavelength range of red light (hereinafter, also referred to as a “red light selective reflective layer”, and a selective reflective layer which functions as a reflective polarizer will be also referred to as a “red light selective reflective polarizer”), and a selective reflective layer having a reflective center wavelength in a wavelength range of green light and in a wavelength range of red light (hereinafter, also referred to as a “green light and red light selective reflective layer”, and a selective reflective layer which functions as a reflective polarizer will be also referred to as a “green light and red light selective reflective polarizer”). Furthermore, the green light and red light selective reflective layer may be a laminate of the green light selective reflective layer and the red light selective reflective layer. Similarly, the green light and red light selective reflective polarizer may be a laminate of the green light selective reflective polarizer and the red light selective reflective polarizer. The green light and red light selective reflective layer and the green light and red light selective reflective polarizer have two reflective center wavelengths, but magnitude between reflectivity at the reflective center wavelength in the wavelength range of the green light and reflectivity at the reflective center wavelength in the wavelength range of the red light does not matter. The former may be larger or smaller than the latter, or the former may be identical to the latter.

The selective reflective polarizer is a so-called narrowband reflective polarizer. The half-width of the peak of the reflectivity of selective reflective layer and the selective reflective polarizer is preferably less than or equal to 100 nm, is more preferably less than or equal to 80 nm, and is even more preferably less than or equal to 70 nm.

On the other hand, the reflective polarizer described above is preferably a so-called broadband reflective polarizer which can function as a reflective polarizer with respect to light in a wide wavelength range compared to the selective reflective polarizer.

It is preferable that the polarized light source unit A including the blue light source and the quantum dot-containing layer includes a blue light selective reflective layer between the quantum dot-containing layer and the reflective polarizer. This is because blue light which is reflected by the blue light selective reflective layer and is incident again on the quantum dot-containing layer becomes the exciting light of the quantum dot in the quantum dot-containing layer, and thus, it is possible to increase a use efficiency of the blue light.

In addition, in a case where the quantum dot-containing layer contains a quantum dot which is excited by exciting light and emits green light, it is preferable that the green light selective reflective layer is disposed between the quantum dot-containing layer and the light source. The green light selective reflective layer may be the green light selective reflective polarizer, or may not have a function as a reflective polarizer.

In a case where the quantum dot-containing layer contains a quantum dot which is excited by exciting light and emits red light, it is preferable that the red light selective reflective layer is disposed between the quantum dot-containing layer and the light source. The red light selective reflective layer may be the red light selective reflective polarizer, or may not have a function as a reflective polarizer.

In addition, in a case where the quantum dot-containing layer contains the quantum dot which is excited by exciting light and emits green light and the quantum dot which is excited by exciting light and emits red light, it is preferable that the green light and red light selective reflective layer is disposed between the quantum dot-containing layer and the light source. The green light and red light selective reflective layer may be the green light and red light selective reflective polarizer, or may not have a function as a reflective polarizer.

As described above, for example, in a case where the ultraviolet light source is used as the light source, it is preferable that the quantum dot-containing layer contains a quantum dot which is excited by exciting light and emits blue light. In this case, it is preferable that the blue light selective reflective layer is disposed between the quantum dot-containing layer and the light source. The blue light selective reflective layer may be the blue light selective reflective polarizer, or may not have a function as a reflective polarizer.

The quantum dot isotropically emits fluorescent light, and thus, the quantum dot-containing layer emits fluorescent light on the light source side. In a case where each of the selective reflective layers described above is disposed between the light source and the quantum dot-containing layer, such fluorescent light can return to the exiting side, and thus, it is possible to increase a use efficiency of light. Thus, increasing the use efficiency of the light is effective for improving luminance. In addition, increasing the use efficiency of the light is also preferable from the viewpoint of enabling the amount of the quantum dot to be used for realizing the same degree of luminance to be reduced. By reducing the use amount of the quantum dot, it is also possible to thin the quantum dot-containing layer.

(3-2. Polarized Light Source Unit B: Aspect Including Quantum Rod-Containing Layer)

(3-2-1. Light Source)

The light source included in the polarized light source unit B is as described in the light source included in the polarized light source unit A which includes the quantum dot-containing layer.

(3-2-2. Quantum Rod-Containing Layer)

The quantum rod-containing layer can he referred to the above description relevant to the quantum dot-containing layer except that a quantum rod is used instead of the quantum dot.

The quantum rod, as with the quantum dot, is a fluorescent body having a discrete energy level due to a quantum confinement effect. The quantum rod is different from the quantum dot in that the fluorescent light which is excited by exciting light and emits light is polarized light. In general, the quantum rod has a shape having anisotropy, such as an acicular shape, a cylindrical shape, a rotational ellipsoidal shape, and a polygonal columnar shape. The quantum rod, for example, can be referred to as paragraphs 0005 to 0032 and 0049 to 0051 of JP2014-502403A, the specification of U.S. Pat. No. 7,303,628B, the literature (Peng, X. G.; Manna, L.; Yang, W. D.; Wickham, j.; Scher, E.; Kadavanich, A.; Alivisatos, A. P. Nature 2000, 404, 59-61), and the literature (Manna, L.; Scher, E. C.; Alivisatos, A. P. j. Am. Chem. Soc. 2000, 122, 12700-12706). In addition, the quantum rod is also available as a commercially available product.

The average long axis length of the quantum rod (the average value of a long axis length) is not particularly limited, but is preferably in a range of 8 to 500 nm, and is more preferably in a range of 10 to 160 nm, from the viewpoint of light emitting properties, a light emission efficiency, and the like. The average long axis length described above is a value obtained by measuring long axis lengths of arbitrarily selected 20 or more quantum rods with a microscope (for example, a transmission type electron microscope), and by arithmetically averaging the measured long axis lengths.

In addition, the long axis of the quantum rod indicates a line segment in which a line segment crossing the quantum rod becomes the longest in a two-dimensional image of the quantum rod obtained by observing the quantum rod with a microscope (for example, a transmission type electron microscope). The short axis indicates a line segment which is orthogonal to the long axis and in which a line segment crossing the quantum rod becomes the longest.

The average short axis length of the quantum rod (the average value of a short axis length) is not particularly limited, but is preferably in a range of 0.3 to 20 nm, and is more preferably in a range of 1 to 10 nm, from the viewpoint of light emitting properties, a light emission efficiency, and the like. The average short axis length described above is a value obtained by measuring short axis lengths of arbitrarily selected 20 or more quantum rods with a microscope (for example, a transmission type electron microscope), and by arithmetically averaging the measured short axis lengths.

An aspect ratio of the quantum rod (long axis length of quantum rod/short axis length of quantum rod) is not particularly limited, but is preferably greater than or equal to 1.5, and is more preferably greater than or equal to 3.0, from the viewpoint of more excellent light emitting properties, and from the viewpoint of suppressing a decrease in a light emission efficiency, and the like. The upper limit is not particularly limited, but is preferably less than or equal to 20 from the viewpoint of handleability. The aspect ratio described above is the average value, and is a value obtained by measuring aspect ratios of arbitrarily selected 20 or more quantum rods with a microscope (for example, a transmission type electron microscope), and by arithmetically averaging the measured aspect ratios.

(3-2-3. Selective Reflective. Polarizer)

Here, in a case where the blue light source is used as the light source as described in the aspect including the quantum dot-containing layer of the polarized light source unit A, at least a part of blue light which exits from the blue light source and is incident on the quantum rod-containing layer is transmitted through the quantum rod-containing layer, and thus, it is possible to embody white light along with the fluorescent light emitted from the quantum rod-containing layer. In this case, it is preferable that the blue light which has been transmitted through the quantum rod-containing layer is also incident on the condensing sheet as polarized light, from the viewpoint of preventing a decrease in a use efficiency of light due to the absorption of the backlight side polarizer of the liquid crystal panel. For this reason, it is preferable that the blue light selective reflective polarizer having a reflective center wavelength in a wavelength range of blue light is disposed between the quantum rod-containing layer and the condensing sheet. The selective reflective polarizer is as described above.

In addition, as with the polarized light source unit A including the quantum dot-containing layer, it is also preferable that the polarized light source unit B includes the selective reflective layer in order to allow the fluorescent light emitted from the quantum rod contained in the quantum rod-containing layer to return to the exiting side from the light source side. For example, it is preferable that the polarized light source unit B including a quantum rod layer containing a quantum rod which is excited by exciting light and emits green light and a quantum rod which is excited by exciting light and emits red light includes the green light and red light selective reflective layer. It is preferable that such a selective reflective layer is the selective reflective polarizer. This is because the selective reflective polarizer can allow polarized light emitted from the quantum rod to return to the exiting side while maintaining a polarization state of the polarized light.

[Liquid Crystal Display Device]

A liquid crystal display device according to an aspect of the present invention includes at least the backlight unit described above, and a liquid crystal panel.

<4. Configuration of Liquid Crystal Display Device>

In general, the liquid crystal panel includes at least a visible side polarizer, the liquid crystal cell, and the backlight side polarizer. The driving mode of the liquid crystal cell is not particularly limited, and various modes such as a twisted nematic (TN) mode, a super twisted nematic (STN) mode, a vertical alignment (VA) mode, an in-plane switching (IPS) mode, and an optically compensated bend cell (OCB) mode can be used. It is preferable that the liquid crystal cell is in the VA mode, the OCB mode, the IPS mode, or the TN mode, but the liquid crystal cell is not limited thereto. The configuration illustrated in FIG. 2 of JP2008-262161A is exemplified as an example of the configuration of the liquid crystal display device in the VA mode. However, the specific configuration of the liquid crystal display device is not particularly limited, and a known configuration can be adopted.

In one embodiment of the liquid crystal display device, the liquid crystal display device includes a liquid crystal cell in which a liquid crystal layer is sandwiched between facing substrates of which at least one includes an electrode, and the liquid crystal cell is configured by being arranged between two polarizers. The liquid crystal display device includes the liquid crystal cell in which a liquid crystal is sealed between upper and lower substrates, changes the orientation state of the liquid crystal by applying a voltage, and thus, displays an image. Further, as necessary, the liquid crystal display device includes an associated functional layer such as a polarizing plate protective film or an optical compensation member performing optical compensation, and an adhesive layer. In addition, a surface layer such as a forward scattering layer, a primer layer, an antistatic layer, and an undercoat layer may be disposed along with (or instead of) a color filter substrate, a thin layer transistor substrate, a lens film, a diffusion sheet, a hard coat layer, an anti-reflection layer, a low reflection layer, an antiglare layer, and the like.

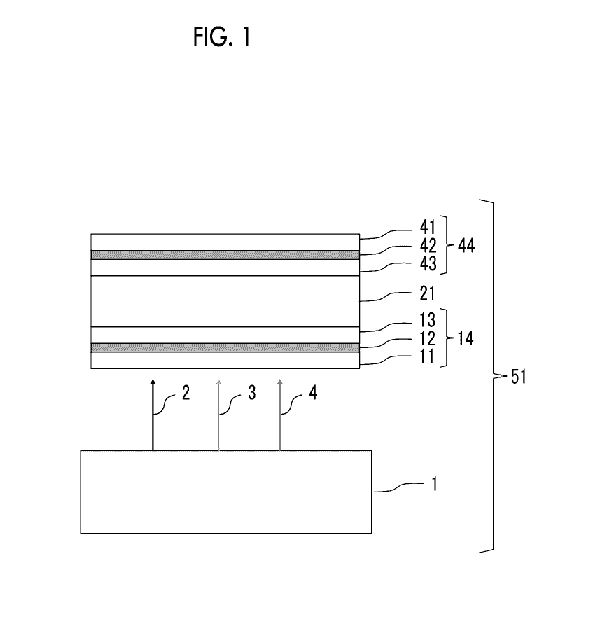

In FIG. 1, an example of the liquid crystal display device according to the aspect of the present invention is illustrated. A liquid crystal display device 51 illustrated in FIG. 1 includes a backlight side polarizing plate 14 on a surface of a liquid crystal cell 21 on a backlight side. The backlight side polarizing plate 14 may or may not include a polarizing plate protective film 11 on a surface of a backlight side polarizer 12 on the backlight side, and it is preferable that the backlight side polarizing plate 14 includes the polarizing plate protective film 11 on the surface of the backlight side polarizer 12 on the backlight side.

It is preferable that the backlight side polarizing plate 14 has a configuration in which the polarizer 12 is sandwiched between two polarizing plate protective films 11 and 13.

Herein, a polarizing plate protective film on a side close to the liquid crystal cell with respect to the polarizer indicates an inner side polarizing plate protective film, and a polarizing plate protective film on a side separated from the liquid crystal cell with respect to the polarizer indicates an outer side polarizing plate protective film. In the example illustrated in FIG. 1, the polarizing plate protective film 13 is the inner side polarizing plate protective film, and the polarizing plate protective film 11 is the outer side polarizing plate protective film.

The backlight side polarizing plate may include a phase difference film as the inner side polarizing plate protective film on the liquid crystal cell side. A known cellulose acylate film or the like can be used as such a phase difference film.

The liquid crystal display device 51 includes a display side polarizing plate 44 on a surface of the liquid crystal cell 21 on a side opposite to the backlight side. The display side polarizing plate 44 has a configuration in which a polarizer 42 is sandwiched between two polarizing plate protective films 41 and 43. The polarizing plate protective film 43 is the inner side polarizing plate protective film, and the polarizing plate protective film 41 is the outer side polarizing plate protective film.

A backlight unit 1 included in the liquid crystal display device 51 is as described above.

The liquid crystal cell, the polarizing plate, the polarizing plate protective film, and the like configuring the liquid crystal display device according to the aspect of the present invention are not particularly limited, and a member prepared by a known method or a commercially available product can be used without any limitation. In addition, a known interlayer such as an adhesive layer can also he disposed between the respective layers.

### EXAMPLES

Hereinafter, the present invention will be described in more detail on the basis of the following examples. Materials, use amounts, ratios, treatment contents, treatment sequences, and the like of the following examples can be suitably changed unless the changes cause deviance from the gist of the present invention. Therefore, the range of the present invention will not be restrictively interpreted by the following specific examples.

A light emission center wavelength, reflective center wavelength, and half-width described below were obtained by a spectrophotometer (UV-3150 manufactured by SHIMADZU CORPORMION).

A refractive index described below was measured by a MULTI-WAVELENGTH ABBE REFRACTOMETER DR-M2 manufactured by ATAGO LTD. A filter of “DR-M2 DICHROIC FILTER 589 (D) nm, Product Number: RE-3520” was used at the time of performing the measurement.

An incidence side described below indicates being positioned on an incidence side in evaluation described below which is performed by disposing a backlight unit into which each condensing sheet of each example and comparative example is incorporated in a liquid crystal display device, and an exiting side indicates being positioned on an exiting side in the same evaluation.

### Example 1

1. Preparation of Condensing Sheet (Prism Sheet)

An ultraviolet ray curable resin (PAK01, manufactured by Toyo Gosei Co., Ltd) was applied onto an acrylic film having a thickness of 0.09 mm, was pressed by a metal mold in which a prismatic shape of which the sectional surface was an isosceles triangle having an apex angle of 90 degrees was formed on a surface at a pitch of 50 μm, was irradiated with 1000 mJ/cm² of an ultraviolet ray from the acrylic film side by using an ultraviolet ray lamp having a center wavelength of 365 nm, and thus, the ultraviolet ray curable resin was cured. After that, the acrylic film was peeled off from the metal mold.

Thus, two prism sheets (nd=1.50) in which, a plurality of prism arrays were arranged in parallel were prepared.

2. Reflective Polarizer

A reflective polarizer (APF, manufactured by Sumitomo 3M Limited) extracted from a commercially available tablet terminal (Kindle Fire HD, manufactured by Amazon.com, Inc.) described below was used as a reflective polarizer.

3. Assembling of Backlight Unit

A commercially available tablet terminal (Kindle Fire HD, manufactured by Amazon.com, Inc., light source: white light source) was disassembled, and thus, a backlight unit was extracted. The backlight unit was disposed on a diffusion sheet, the two prism sheets in which the plurality of prism arrays were arranged in parallel were arranged such that the prism arrays of both prism sheets were orthogonal to each other (the prism arrays of both prism sheets were positioned on the exiting side), and the reflective polarizer was disposed thereon.

The reflective polarizer and the two prism sheets were removed from the extracted backlight unit, instead, the reflective polarizer prepared in 2. described above was disposed on the diffusion sheet.

The two prism sheets prepared in 1. described above were superimposed such that the prism arrays of both prism sheets were orthogonal to each other and the prism arrays of both prism sheets were positioned on the exiting side, and were disposed on the reflective polarizing plate described above.

Thus, a backlight unit of Example 1 was obtained.

### Example 2

1. Preparation of Micro Lens Array Sheet (Condensing Sheet Including Plurality of Convex Portions on Surface on Exiting Side)

A micro lens array was prepared in which micro lenses (convex portions) having a semispherical shape were two-dimensionally arranged on a surface of an acrylic resin base sheet on the exiting side by using an acrylic resin and by a method described in paragraphs 0033 to 0053 of JP2008-83685A.

The height of the micro lens (a distance from a bottom surface to an apex of a semisphere in a vertical direction), the width of the micro lens (the diameter of the bottom surface), and the thickness of the micro lens array sheet are shown in Table 1 described below.

2. Assembling of Backlight Unit

A backlight unit was obtained by the same method as that in Example 1 except that the micro lens array prepared in 1. described above was disposed instead of the prism sheet in 3. of Example 1

### Example 3

A backlight unit was obtained by the same method as that in Example 2 except that the thickness of the micro lens array sheet was changed by changing the thickness of the base sheet.

### Example 4

1. Preparation of Laminated Sheet (Condensing Sheet Including Plurality of Convex Portions Protruding to Exiting Side on Interface between Two Layers)

A micro lens array sheet having a structure illustrated in paragraph 0017 and FIG. 1A of JP2007-079208A was prepared by using an acrylic resin (nd=1.46) as a material of a first light-transmitting substrate and a second light-transmitting substrate, and by using a resin (Product Name: WORLD ROCK, manufactured by Kyoritsu Chemical & Co., Ltd., nd =1.59) having nd higher than that of the acrylic resin described above as a high refractive index resin in a method described in paragraphs 0028 to 0034 of JP2007-079208A. A plurality of semicircular shapes (micro lenses) protruding to the exiting side were formed on the interface between the second light-transmitting substrate which was the uppermost layer on the exiting side and the high refractive index resin.

The height of the micro lens (a distance from a bottom surface to an apex of a semisphere in a vertical direction), the width of the micro lens (the diameter of the bottom surface), and the thickness of the laminated sheet are shown in Table I described below.

2. Assembling of Backlight Unit

A backlight unit was obtained by the same method as that in Example 1 except that the laminated sheet prepared in 1. described above was disposed instead of the prism sheet in 3, of Example 1.

### Example 5

A backlight unit was obtained by the same method as that in Example 4 except that the height of the micro lens was changed.

### Example 6

A backlight unit was obtained by the same method as that in Example 4 except that the height and the width of the micro lens were changed.

### Example 7

A backlight unit was obtained by the same method as that in Example 6 except that the thickness of the laminated sheet was changed.

### Example 8

1. Preparation of GRIN Rod Lens Array Sheet Having Cylindrical Shape

A GRIN rod lens array sheet was prepared in which a plurality of GRIN rod lenses having a cylindrical shape were embedded in a matrix by a method described in paragraphs 0036 to 0041 of JP2007-34046A.

The pitch of the GRIN rod lens (a distance between rods), the width of the GRIN rod lens (a diameter of a circle which is a sectional shape of a cylinder), and a sheet thickness are shown in Table 1 described below.

2. Assembling of Backlight Unit

A backlight unit was obtained by the same method as that in Example 1 except that the GRIN rod lens array sheet prepared in 1. described above was disposed instead of the prism sheet in 3. of Example 1.

### Example 9

A backlight unit was obtained by the same method as that in Example 8 except that the thickness of the GRIN rod lens array sheet, the pitch of the rod lens, and the width of the rod lens were changed.

### Example 10

A backlight unit was assembled by using the GRIN rod lens array sheet prepared in Example 9 and by the following method.

Four commercially available tablet terminals (Kindle Fire HDX, manufactured by Amazon.com, Inc.) were disassembled, a backlight unit was extracted from each of the tablet terminals, and thus, four backlight units were obtained in total. Each of the backlight units included a blue light source, contained a quantum dot which is excited by exciting light and emits green light and a quantum dot which is excited by exciting light and emits red light in a quantum dot-containing layer, and included a quantum dot sheet in which barrier films were laminated on both surfaces of the quantum dot-containing layer. In the four backlight units, the barrier films on both surfaces were peeled off from the quantum dot sheet obtained from two backlight units, the barrier film on one surface was peeled off from the quantum dot sheet obtained from the other two backlight units. Four quantum dot sheets obtained as described above were laminated such that the barrier films were arranged on both outer layers, and thus, a quantum dot sheet having a total thickness of 510 μm was obtained in which the barrier films having a thickness of 52.5 μm were provided on both outermost layers, respectively.

The obtained quantum dot sheet was incorporated in one disassembled commercially available tablet terminal (Kindle Fire HDX, manufactured by Amazon.com, Inc.) described above, the reflective polarizer used in Example 1 was disposed instead of two prism sheets which were disposed on the quantum dot sheet before being disassembled, and the GRIN rod lens array sheet described above was disposed on the reflective polarizer.

Thus, a backlight unit of Example 10 was obtained.

Green light and red light which are emitted from the quantum dot, and blue light which is emitted from the blue light source and is transmitted through the quantum dot sheet exit from the quantum dot sheet described above.

### Example 11

1. Preparation of Blue Light Selective Reflective Polarizer

With reference to W2012-108471A, a λ/4 plate was prepared on a commercially available cellulose acylate-based film (TD60, manufactured by Fujitilm Corporation) by using a discotic liquid crystal. Re (450) of the obtained λ/4 plate was 137 nm, Re (550) of the λ/4 plate was 125 nm, Re (630) of the λ/4 plate was 120 nm, the thickness of a liquid crystal layer was approximately 0.8 and the thickness of the liquid crystal layer including a support (a triacetyl cellulose (TAC) film) was approximately 60 μm.

With reference to pp. 60 to 63 of Fuji Film research & development No. 50 (2005), a liquid crystal having refractive index anisotropy of Δn 0.16 was used, the added amount of a chiral agent was changed, and thus, a blue light selective reflective polarizer formed by immobilizing a cholesteric liquid crystalline phase having a reflective center wavelength of 450 nm and a half-width of 50 nm was prepared on the λ/4 plate described above.

The total thickness of the laminate prepared in the steps described above (a laminate of the cellulose acylate-based film, the λ/4 plate, and the blue light selective reflective polarizer) was approximately 63 μm.

2. Assembling of Backlight Unit

A commercially available tablet terminal (Kindle Fire HDX, manufactured by Amazon.com, Inc.) was disassembled, and thus, a backlight unit was extracted.

Two prism sheets disposed on a quantum dot sheet were removed, instead, the laminate prepared in 1. described above was disposed such that the blue light selective reflective polarizer, the λ/4 plate, and the cellulose acylate-based film were arranged in this order towards the exiting side, the reflective polarizer used in Example 1 was disposed thereon, and thus, the GRIN rod lens array sheet described above was disposed on the reflective polarizer.

Thus, a backlight unit of Example 11 was obtained.

### Example 12

1. Preparation of Green Light and Red Light Selective Reflective Polarizer

A λ/4 plate was prepared on a cellulose acylate-based film by the same method as that in Example 11.

With reference to pp. 60 to 63 of Fuji Film research & development No. 50 (2005), the added amount of a chiral agent to be used was changed, a liquid crystal having refractive index anisotropy of αn=0.15 was used, and thus, two layers formed by immobilizing a cholesteric liquid crystalline phase (a first layer and a second layer) were formed on the prepared λ/4 plate by performing coating.

Thus, among the two layers formed on the λ/4 plate, the reflective center wavelength of the first layer was 530 nm, the half-width of the first layer was 50 nm, the film thickness of the first layer was 2.0 μm, the reflective center wavelength of the second layer was 650 nm, the half-width of the second layer was 60 nm, and the film thickness of the second layer was 2.5 μm.

That is, by laminating the two layers described above, it is possible to obtain a function as a green light and red light selective reflective polarizer.

2. Assembling of Backlight Unit

A backlight unit was obtained by the same method as that in Example 11 except that the laminate of the cellulose acylate-based film, the λ/4 plate, and the green light and red light selective reflective polarizer prepared in 1. described above was disposed between the blue light source and the quantum dot sheet such that the cellulose acylate-based film, the λ/4 plate, and the green light and red light selective reflective polarizer were arranged in this order towards the exiting side.

### Example 13

1. Preparation of Quantum Rod-Containing Layer

With reference to the specification of U.S. Pat. No. 7,303,628B, the literature (Peng, X. G.; Manna, L.; Yang, W. D.; Wickham, j.; Scher, E.; Kadavanich, A.; Alivisatos, A. P. Nature 2000, 404, 59-61), and the literature (Manna, L.; Scher, E. C.; Alivisatos, A. P. j. Am. Chem. Soc. 2000, 122, 12700-12706), a quantum rod 1 which emitted fluorescent light of green light having a light emission center wavelength of 540 nm and a half-width of 40 nm when blue light of a blue light emitting diode was incident thereon, and a quantum rod 2 which emitted fluorescent light of red light having a light emission center wavelength of 645 nm and a half-width of 30 nm were prepared. The shape of the quantum rods 1 and 2 was a cuboidal shape, and the average long axis length of the quantum rod was 30 nm. Furthermore, the average long axis length of the quantum rod was observed by a transmission type electron microscope.

A quantum rod-containing layer (a quantum rod-dispersed polyvinyl alcohol (PVA) sheet in which the quantum rods were dispersed) was prepared by using the prepared quantum rod and by the following method.

An isophthalic acid-copolymerized polyethylene terephthalate (hereinafter, referred to as “amorphous PET”) sheet, in which 6 mol % of an isophthalic acid was copolymerized, was prepared as a base. The glass transition temperature of the amorphous PET is 75° C., A laminate of the amorphous PET base and the quantum rod-containing layer was prepared as described below. Here, the quantum rod-containing layer includes the quantum rods 1 and 2 described above in polyvinyl alcohol (PVA) which is a matrix. Furthermore, the glass transition temperature of PVA is 80° C.

A PVA powder having a degree of polymerization of greater than or equal to 1000 and a degree of saponification of greater than or equal to 99% was added to water at a concentration of 4 to 5 mass %, each of the quantum rods 1 and 2 described above was added to water at a concentration of 1 mass %, and thus, an aqueous solution of quantum rod-containing PVA was prepared.

The aqueous solution of the quantum rod-containing PVA described above was applied onto the amorphous PET base having a thickness of 200 μm, and was dried at a temperature of 50° C. to 60° C., and thus, a quantum dot-containing layer having a thickness of 25 μm was prepared on the amorphous PET base.

2. Assembling of Backlight Unit

A backlight unit was obtained by the same method as that in Example 12 except that only the quantum rod-containing layer prepared in 1. described above was transferred onto the selective reflective polarizer side of the laminate of the cellulose acylate-based film, the λ/4 plate, and the green light and red light selective reflective polarizer, and thus, the quantum dot sheet was used instead of the quantum rod-containing layer prepared in 1. described above, and the reflective polarizer was removed.

### Example 14

A backlight unit was obtained by the same method as that in Example 1 except that a metal mold to be used was changed to a metal mold in which a prismatic shape of which the sectional surface was an isosceles triangle having an apex angle of 110 degrees was formed on a surface at a pitch of 50 μm, in 1. of Example 1. Furthermore, the thickness of the obtained prism sheet was 45 μm, and in-plane retardation Re measured by the following method was 10 nm.

### Example 15

A condensing sheet, which was a laminated sheet of two layers, included a convex portion (a prismatic shape of which the sectional surface was an isosceles triangle having an apex angle of 110 degrees) protruding to the exiting side on an interface between the two layers, and included a flat surface on the incidence side and a fiat surface on the exiting side, was prepared by the following method.

A liquid in which 1 part by mass of an silicone acrylic primer (CT-P10, manufactured by ASAHI GLASS CO., LTD., an effective component of 15 mass %) was diluted with 15 parts by mass of a diluted solution (isopropyl alcohol:isobutyl acetate=9:5 (mass ratio)) was applied onto the surface of the condensing sheet prepared in Example 14 (prism sheet, nd=1.50) on which a prismatic shape was formed by being pressed with a metal mold by using a wire bar coater of #12. was dried at 60° C. for 10 minutes, and thus, a layer with a primer (a film thickness of 15 nm) was formed.

After that, a liquid in which 10 parts by mass of a resin solution (CYTOP CTL-110A, manufactured by ASAHI GLASS CO., LTD., an solution of an amorphous perfluorofluorine resin (terminal group-COOH) of 10 mass %) was diluted with 90 parts by mass of a perfluoro solvent (CT-solv, 100, manufactured by ASAHI GLASS CO., LTD.) was applied onto the same surface by using a wire bar coater of #12, was dried at 90° C. for 1 hour, and after that, coating and drying were additionally repeated 4 times (5 times in total), and thus, a condensing sheet was obtained in which a layer of low refractive index (nd=1.20) was formed on a prism sheet (a layer of high refractive index).

A backlight unit was obtained by the same method as that in Example 1 except that the obtained condensing sheet was used.

### Example 16

A condensing sheet, which was a laminated sheet of two layers, included a convex portion (a prismatic shape of which tile sectional surface was an isosceles triangle having an apex angle of 110 degrees) protruding to the exiting side on an interface between the two layers, and included a flat surface on the incidence side and a flat surface on the exiting side, was prepared by the following method.

A composition described below was applied onto the surface of the condensing sheet prepared in Example 14 (prism sheet, nd =1.50) on which a prismatic shape was formed by being pressed with a metal mold by using a wire bar coater of #12, was dried at 90° C. for 1 hour, and after that, coating and drying were additionally repeated 4 times, and thus, a condensing sheet was obtained in which a layer of low refractive index (nd=1.30) was formed on a prism sheet (a layer of high refractive index). A backlight unit was obtained by the same method as that in Example 1 except that the obtained condensing sheet was used.

(Preparation of Composition)

A hydrolysis and condensation reaction was performed by using methyl triethoxy silane. At this time, a solvent which was used is ethanol. Components described below were mixed by a stirrer, and thus, a composition was prepared.

Hydrolyzed Condensate of Methyl Triethoxy Silane: 10 parts by mass

Propylene Glycol Monomethyl. Ether Acetate (PGMEA): 72 parts by mass

Ethyl 3-Ethoxy Propionate (EEP): 18 parts by mass

Surfactant (EMULSOGEN-COL-020, manufactured by Clariant Japan K.K.): 2 parts by mass

Hollow Silica Dispersion Liquid (THRULYA 2320, manufactured by JGC Catalysts and Chemicals Ltd.): 25 parts by mass

### Example 17

A layer of low refractive index (nd=1.20) was formed on the surface of the condensing sheet prepared in Example 14 (prism sheet, nd=1.50) on a side opposite to the surface on which the prismatic shape was formed by being pressed with the metal mold by the same method as that in Example 15, and thus, a condensing sheet was obtained. The obtained condensing sheet included a convex portion (a prismatic shape of which the sectional surface was an isosceles triangle having an apex angle of 110 degrees) on the surface on the exiting side (the surface of the prism sheet (the layer of high refractive index)), and included a flat surface on the incidence side (the surface of the layer of low refractive index).

A backlight unit was obtained by the same method as that in Example 1 except that the obtained condensing sheet was used.

### Example 18

A condensing sheet was prepared by the same method as that in Example 1.5 except that the number of times of coating and drying of a diluted solution of a resin solution (CYTOP CTL-110A, manufactured by ASAHI GLASS CO., LTD., a solution of an amorphous perfluoro fluorine resin (terminal group-COOH) of 10 mass %) was changed from 5 times in total to 3 times in total in Example 15. The prepared condensing sheet included a convex portion (a prismatic shape of which the sectional surface was an isosceles triangle having an apex angle of 110 degrees) on the surface on the exiting side (the surface of the layer of low refractive index), and included a flat surface on the incidence side (the surface of the prism sheet (the layer of high refractive index) on a side opposite to the surface including a prism array).

A backlight unit was obtained by the same method as that in Example 1 except that the obtained condensing sheet was used.

### Example 19

A layer with a primer (a film thickness of 15 nm) was formed on the surface of the condensing sheet prepared in Example 18 on the incidence side (the surface of the prism sheet on a side opposite to the surface including a prism array) by the same method as that in Example 15.

After that, a diluted solution of a resin solution which was prepared by the same method as that in Example 15 was applied onto the same surface by using a wire bar coater of #12, was dried at 90° C. for 1 hour, and after that, coating and drying were repeated 2 times, and thus, a layer of low refractive index (nd=1.20) was formed.

Thus, a condensing sheet, which included the layer of low refractive index, the prism sheet (the layer of high refractive index), and the layer of low refractive index in this order from the incidence side towards the exiting side, included a fiat surface on the incidence side (the surface of the layer of low refractive index on the incidence side), and included a convex portion (a prismatic shape of which the sectional surface was an isosceles triangle having an apex angle of 110 degrees) on the surface on the exiting side (the surface of the layer of low refractive index on the exiting side), was obtained.

A backlight unit was obtained by the same method as that in Example 1 except that the obtained condensing sheet was used.

### Example 20

A coating liquid for a layer of low refractive index prepared as described below was applied onto the surface of the condensing sheet prepared in Example 1 (prism sheet, nd=1.50) on which a prismatic shape was formed by being pressed with a metal mold by using a wire bar coater of #12, was dried at 60° C. for 60 seconds, and then, was cured with ultraviolet ray at irradiance of 600 mW/cm² and irradiation dose of 300 mJ/cm² by using an air-cooled metal halide lamp (manufactured by EYE GRAPHICS CO., LTD.) under an environment which was subjected to nitrogen purge such that an atmosphere having an oxygen concentration of less than or equal to 0.1 volume% was obtained. After that, coating and drying were repeated 4 times, and thus, a prism sheet was obtained in which a layer of low refractive index (a refractive index of 1.35) was formed. The prepared condensing sheet included a convex portion (a prismatic shape of which the sectional surface was an isosceles triangle having an apex angle of 110 degrees) on the surface on the exiting side (the surface of the layer of low refractive index), and included a flat surface on the incidence side (the surface of the prism sheet (the layer of high refractive index) on a side opposite to the surface including a prism array).

(Coating Liquid for Layer of Low Refractive Index)

Components described below were respectively mixed, propylene glycol monomethyl ether acetate (PGMEA) was added thereto such that the content of the propylene glycol monomethyl ether acetate (PGMEA) in the total solvent became 30 mass %, and then, the mixture was diluted with methyl ethyl ketone, and finally, a concentration of solid contents became 5 mass %. The prepared diluted solution was put into a separable flask of glass which was provided with a stirrer, was stirred at room temperature for 1 hour, was filtered with a polypropylene depth filter having a hole diameter of 0.5 μm, and thus, a coating liquid for a layer of low refractive index was obtained.

Mixture of Dipentaerythritol Pentaacrylate and Dipentaerythritol Hexaacrylate (DPHA, manufactured by Nippon Kayaku Co., Ltd.): 42 mass %

Hollow Silica Dispersion Liquid (THRUM 4320, manufactured by JGC Catalysts and Chemicals Ltd.): 53 mass %

Silicone-Based Compound (X22-164C, manufactured by Shin-Etsu Chemical Co., Ltd., a leveling agent which also functions as an antifouling agent): 2 mass %

Compound Represented by Formula Described below (Irg 127, manufactured by BASF SE): 3 mass %

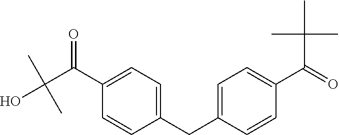 [SMILES: CC(C)(C)C(=O)c1ccc(Cc2ccc(C(=O)C(C)(C)O)cc2)cc1]

### Example 21

A liquid in which 1 part by mass of a silicone acrylic primer (CT-P10, manufactured by ASAHI GLASS CO., LTD., an effective component of 15 mass %) was diluted with 15 parts by mass of a diluted solution (isopropyl alcohol:isobutyl acetate=9:5 (mass ratio)) was applied onto the surface of the condensing sheet prepared in Example 14 (prism sheet, nd=1.50) on which a prismatic shape was formed by being pressed with a metal mold by using a wire bar coater of #12, was dried at 60° C. for 10 minutes, and thus, a layer with a primer (a film thickness of 15 nm) was formed.

After that, a liquid in which 10 parts by mass of a coating liquid (CYTOP CTL-110A, manufactured by ASAHI GLASS CO., LTD., a solution of an amorphous perfluoro fluorine resin (terminal group-COOH) of 10 mass %) was diluted with 90 parts by mass of a perfluoro solvent (CT-solv.100, manufactured by ASAHI GLASS CO., LTD.) was applied onto the same surface by using a wire bar coater of #12, was dried at 90° C. for 1 hour, and after that, coating and drying were repeated 4 times, and thus, a layer of low refractive index (nd=1.20) was formed on a prism sheet (a layer of high refractive index).

After that, similarly, a layer of low refractive index was formed on the surface (having a flat surface shape) of the prism sheet on a side opposite to the surface on which the layer of low refractive index described above was formed. Thus, a condensing sheet was obtained in which the layers of low refractive index (nd=1.20) were formed on both surfaces of the prism sheet. The prepared condensing sheet included a convex portion (a prismatic shape of which the sectional surface was an isosceles triangle having an apex angle of 110 degrees) on the surface on the exiting side (the surface of the layer of low refractive index on the exiting side), and included a flat surface on the incidence side (the surface of the layer of low refractive index on the incidence side).

A backlight unit was obtained by the same method as that in Example 1 except that the obtained condensing sheet was used.

### Example 22

In Example 10, the backlight unit was assembled by using the condensing sheet prepared in Example 20 instead of the GRIN rod lens array sheet prepared in Example 9,

### Example 23

In Example 11, the backlight unit was assembled by using the condensing sheet prepared in Example 20 instead of the GRIN rod lens array sheet prepared in Example 9.

### Example 24

In Example 12, the backlight unit was assembled by using the condensing sheet prepared in Example 20 instead of the GRIN rod lens array sheet prepared in Example 9.

### Example 25

In Example 13, the backlight unit was assembled by using the condensing sheet prepared in Example 20 instead of the GRIN rod lens array sheet prepared in Example 9.

### Comparative Example 1

A backlight unit extracted by disassembling a commercially available tablet terminal (Kindle Fire manufactured by Amazon.com, Inc., light source: white light source) was set to a backlight unit of Comparative Example 1. The configuration of the backlight unit is as described in Example 1 described above.

### Comparative Example 2

In a backlight unit extracted by disassembling a commercially available tablet terminal (Kindle Fire HD, manufactured by Amazon.com, Inc., light source: white light source), positions of a reflective polarizer and two prism sheets were switched, and the two prism sheets were arranged on the reflective polarizer. As with Comparative Example 1, the two prism sheets were arranged such that prism arrays of both prism sheets were orthogonal to each other and the prism arrays were positioned on the exiting side.

Thus, a backlight unit of Comparative Example 2 was obtained.

### Comparative Example 3

In a backlight unit extracted by disassembling commercially available tablet terminal (Kindle Fire HD, manufactured by Amazon.com, Inc., light source: white light source), an arrangement order of a diffusion sheet, two prism sheets, and a reflective polarizer was changed to an order of the reflective polarizer, the diffusion sheet, and the two prism sheets towards the exiting side.

Thus, a backlight unit of Comparative Example 3 was obtained.

### Comparative Example 4

A backlight unit was extracted by disassembling a commercially available tablet terminal (Kindle Fire HDX, manufactured by Amazon.com, Inc., light source: including blue light source and quantum dot sheet). In the backlight unit, two prism sheets in which a plurality of prism arrays were arranged in parallel were arranged on the quantum dot sheet such that prism arrays of both prism sheets were orthogonal to each other (the prism arrays of both prism sheets were positioned on the exiting side). The reflective polarizer used in Example 1 was disposed between the quantum dot sheet and the two prism sheets.

Thus, a backlight unit of Comparative Example 4 was obtained.

### Comparative Example 5

A backlight unit was obtained by the same method as that in Example 2 except that polyethylene terephthalate (PET) was used instead of the acrylic resin in the preparation of the micro lens array.

<Evaluation Method>

1. Measurement of Depolarization Degree of Condensing Sheet

A depolarization degree of each condensing sheet used in the examples and the comparative examples was measured by the following method.

Two linear polarizing plates (POLAR-50N, manufactured by Luceo Co., Ltd.) were arranged on a diffusion plate of a white light source (FUJICOLOR LIGHT BOX 5000, manufactured by Fujifilm Corporation) such that transmission axes were orthogonal to each other (crossed nicols arrangement), and the condensing sheet was disposed between the two linear polarizing plates. Here, the condensing sheet was disposed in the backlight unit such that an incidence side of light incident from a polarized light source unit was positioned on an incidence side of light from the white light source described above.

Thus, in a state where the components were arranged as described above, the condensing sheet was rotated in the plane parallel to the linear polarizing plate, and thus, luminance at an angle in which the luminance became the darkest (Tcross) was measured.

Next, one of the two linear polarizing plates was rotated by 90 degrees, and was in parallel nicols arrangement, and thus, luminance (Tpara) in this state was measured.

In the measurement of the luminance Tcross and the luminance Tpara described above, a distance between each linear polarizing plate and the condensing sheet was 5 mm.

From the luminance Tcross and the luminance Tpara which were measured, a depolarization degree DI was calculated by Expression I described above.

In Example 1, Comparative Examples 1 to 4, and Examples 14 to 23, two condensing sheets were used by being superimposed. At this time, the two condensing sheets were arranged such that arrays of convex portions of the condensing sheets (existing on the surface on the exiting side or on the interface) were orthogonal to each other, and the convex portion protruded to the exiting side. In the examples and the comparative examples where the two condensing sheets were used by being superimposed, a depolarization degree DI of one condensing sheet was obtained. Furthermore, depolarization degrees DI of the two condensing sheets which were used by being superimposed were the same value.

2. Measurement of Visible Light Reflectivity of Condensing Sheet

A visible light reflectivity on the surface of each condensing sheet used in the examples and the comparative example, which became the surface of the polarized light source unit on the side surface at the time of being disposed on the backlight unit, was measured by the following method.

The surface of each condensing sheet on the polarized light source unit side was irradiated with visible light at each 10 degrees from 0 degrees (a normal direction) in a range of −80 degrees to 80 degrees, and light intensity of transmitted light which had been transmitted through the condensing sheet was measured by using a goniophotometer (GP-5, manufactured by MURAKAMI COLOR RESEARCH LABORATORY CO., Ltd.). A visible light transmittance T was obtained as a value which was obtained by dividing an integrating accumulated value obtained by integrating accumulating the light intensity at each incidence angle by the total amount of light without the condensing sheet, and a visible light reflectivity (Unit: %) was obtained as (1−T)×100.

In the examples and the comparative examples where the two prism sheets were used by being superimposed, a visible light reflectivity of one prism sheet was obtained. Furthermore, visible light reflectivities of the two prism sheets which were used by being superimposed were the same value.

3. Measurement of In-Plane Retardation Re of Condensing Sheet

In-plane retardation Re of each condensing sheet used in the examples and the comparative examples was obtained by the method described above.

In the examples and the comparative examples where the two prism sheets were used by being superimposed, in-plane retardation Re of one prism sheet was obtained. Furthermore, visible light reflectivities of the two prism sheets which were used by being superimposed were the same value.

4. Measurement of Total Amount of Light Exiting from Liquid Crystal Panel

Each backlight unit of the examples and the comparative examples was disposed instead of a backlight unit of a commercially available tablet terminal (Kindle Fire HD, manufactured by Amazon.com, Inc.), and thus, a liquid crystal display device was prepared.

A luminance value was measured at each azimuthal angle of 15 degrees and at each polar angle of 10 degrees on a display surface of the prepared liquid crystal display device, by using a view angle measurement device (EZ-Contrast X188, manufactured by Eldim S.A.), and the results were subjected to integrating accumulation, and thus, the total amount of light was obtained. By using the value of Comparative Example 1 as a standard of 100, the values obtained in the examples and the comparative examples were obtained as a relative value with respect to Comparative Example 1.

As the value obtained as described above becomes larger, luminance of an image displayed on the display surface of the liquid crystal display device is high.

5. Measurement Total Amount of Light Exiting from Backlight Unit

The same measurement as that in 2. described above was performed on the exiting side of each backlight unit of the examples and the comparative examples.

The results described above are shown in Table 1 and Table 2.

TABLE 1

| | Comparative | Comparative | Comparative | Comparative | |
|---|---|---|---|---|---|
| | Example 1 | Example 2 | Example 3 | Example 4 | Example 1 |
| Apex Angle of Prism | 90 Degrees | 90 Degrees | 90 Degrees | 90 Degrees | 90 Degrees |
| Material of Prism Sheet | PET | PET | PET | PET | Acrylic Resin |
| Thickness per Prism Sheet (μm) | 90 | 90 | 90 | 90 | 45 |
| Re of Prism Sheet (nm) | 10000 | 10000 | 10000 | 10000 | 10 |
| Depolarization Degree | 0.17 | 0.17 | 0.17 | 0.17 | 0.0021 |
| Visible Light Reflectivity | 73% | 73% | 73% | 73% | 73% |
| Thickness of Reflective | 26 | 26 | 26 | 26 | 26 |
| Polarizer (μm) | | | | | |
| Thickness of Diffusion Plate | 100 | 100 | 100 | 210 | 100 |
| or Quantum Dot Sheet (μm) | (Diffusion | (Diffusion | (Diffusion | (Quantum | (Diffusion |
| | Plate) | Plate) | Plate) | Dot Sheet) | Plate) |
| Total Thickness (μm) | 306 | 306 | 306 | 416 | 216 |
| Total Amount of Light Exiting from | 100 | 50 | 100 | 60 | 105 |
| Liquid Crystal Panel (Relative Value) | | | | | |
| Total Amount of Light Exiting from | 100 | 100 | 100 | 115 | 100 |
| Backlight Unit (Relative Value) | | | | | |

| | Comparative | | | | | | |
|---|---|---|---|---|---|---|---|
| | Example 5 | Example 2 | Example 3 | Example 4 | Example 5 | Example 6 | Example 7 |
| Convex Portion of | Exiting | Exiting | Exiting | Exiting | Exiting | Exiting | Exiting |
| Micro Lens | Side | Side | Side | Side | Side | Side | Side |
| Height of Micro | 17.5 | 17.5 | 17.5 | 17.5 | 22.5 | 22.5 | 22.5 |
| Lens (μm) | | | | | | | |
| Width of Micro Lens (μm) | 46.5 | 46.5 | 46.5 | 46.5 | 46.5 | 36.5 | 36.5 |
| Material of Micro Lens | PET | Acrylic | Acrylic | Acrylic | Acrylic | Acrylic | Acrylic |
| Array Sheet | | Resin | Resin | Resin | Resin | Resin | Resin |
| Thickness of Micro Lens | 90 | 90 | 45 | 90 | 90 | 90 | 45 |
| Array Sheet (μm) | | | | | | | |
| Re of Micro Lens Array | 10000 | 20 | 10 | 20 | 20 | 20 | 10 |
| Sheet (nm) | | | | | | | |
| Depolarization Degree | 0.1700 | 0.0021 | 0.0010 | 0.0010 | 0.0010 | 0.0010 | 0.0005 |
| Visible Light Reflectivity | 35% | 35% | 35% | 30% | 30% | 30% | 30% |
| Thickness of Reflective | 26 | 26 | 26 | 26 | 26 | 26 | 26 |
| Polarizer (μm) | | | | | | | |
| Thickness of Diffusion Plate (μm) | 100 | 100 | 100 | 100 | 100 | 100 | 100 |
| Total Thickness (μm) | 216 | 216 | 171 | 216 | 216 | 216 | 171 |
| Total Amount of Light Exiting | 50 | 105 | 110 | 115 | 115 | 115 | 120 |
| from Liquid Crystal Panel | | | | | | | |
| (Relative Value) | | | | | | | |
| Total Amount of Light Exiting | 100 | 105 | 105 | 110 | 110 | 110 | 110 |
| from Backlight Unit (Relative | | | | | | | |
| Value) | | | | | | | |

| | Example 8 | Example 9 | Example 10 | Example 11 | Example 12 | Example 13 |
|---|---|---|---|---|---|---|
| Pitch of Rod Lens (μm) | 110 | 60 | 60 | 60 | 60 | 60 |
| Width of Rod Lens (μm) | 30 | 15 | 15 | 15 | 15 | 15 |
| Shape of Rod Lens | Cylinder | Cylinder | Cylinder | Cylinder | Cylinder | Cylinder |
| Material of Rod Lens | Acrylic | Acrylic | Acrylic | Acrylic | Acrylic | Acrylic |
| | Resin | Resin | Resin | Resin | Resin | Resin |
| Thickness of Rod Lens | 90 | 45 | 45 | 45 | 45 | 45 |
| Array Sheet (μm) | | | | | | |
| Re of Rod Lens Array Sheet (nm) | 20 | 10 | 10 | 10 | 10 | 10 |
| Depolarization Degree | 0.0010 | 0.0005 | 0.0005 | 0.0005 | 0.0005 | 0.0005 |
| Visible Light Reflectivity | 30% | 30% | 30% | 30% | 30% | 30% |
| Thickness of Reflective | 26 | 26 | 26 | 26 | 26 | 0 |
| Polarizer (μm) | | | | | | |
| Thickness of Diffusion Plate, | 100 | 100 | 510 | 210 | 210 | 210 |
| Quantum Dot Sheet, | (Diffusion | (Diffusion | (Quantum | (Quantum | (Quantum | (Quantum |
| or Quantum Rod Layer (μm) | Plate) | Plate) | Dot Sheet) | Dot Sheet) | Dot Sheet) | Rod Layer) |
| Total Thickness (μm) | 216 | 171 | 581 | 281 | 281 | 255 |
| Blue Light Selective | — | — | — | Present | Present | Present |
| Reflective Polarizer | | | | | | |
| Green Light and Red Light | — | — | — | | Present | Present |
| Selective Reflective Polarizer | | | | | | |
| Total Amount of Light Exiting | 115 | 120 | 140 | 140 | 145 | 150 |
| from Liquid Crystal Panel | | | | | | |
| (Relative Value) | | | | | | |
| Total Amount of Light Exiting from | 110 | 110 | 125 | 125 | 130 | 135 |
| Backlight Unit (Relative Value) | | | | | | |

(*PET: Polyethylene Terephthalate)

TABLE 2

| | | | | | Example 18 | Example 19 |
|---|---|---|---|---|---|---|
| | | | | | 110 | 110 |
| | | | | | Degrees | Degrees |
| | | | | | (Apex | (Apex |
| | | | | | Angle of | Angle of |
| | | Example 15 | Example 16 | Example 17 | Convex | Convex |
| | | 110 | 110 | 110 | Portion of | Portion of |
| | | Degrees | Degrees | Degrees | Surface of | Surface of |
| | Example 14 | (Apex | (Apex | (Apex | Codensing | Codensing |
| | 110 | Angle of | Angle of | Angle of | Sheet on | Sheet on |
| | Degrees | Prismatic | Prismatic | Prismatic | Exiting | Exiting |
| | (Apex | Shape of | Shape of | Shape of | side | side |
| | Angle of | Prism Sheet | Prism Sheet | Prism Sheet | (Surface of | (Surface of |
| | Prismatic | (Layer of | (Layer of | (Layer of | Layer of | Layer of |
| | Shape of | High | High | High | Low | Low |
| Apex Angle of | Prism | Refractive | Refractive | Refractive | Refractive | Refractive |
| Convex Portion | Sheet) | Index)) | Index)) | Index)) | Index)) | Index)) |
| Refractive Index of Layer | None | 1.20 | 1.30 | 1.20 | 1.20 | 1.20 |
| of Low Refractive Index | | | | | | |
| Depolarization Degree | 0.0015 | 0.0010 | 0.0013 | 0.0006 | 0.0010 | 0.0006 |
| Visible Light Reflectivity | 73% | 50% | 35% | 60% | 60% | 60% |
| Thickness of Reflective | 26 | 26 | 26 | 26 | 26 | 26 |
| Polarizer (μm) | | | | | | |
| Thickness of Diffusion Plate, | 100 | 100 | 100 | 100 | 100 | 100 |
| Quantum Dot Sheet, or | (Diffusion | (Diffusion | (Diffusion | (Diffusion | (Diffusion | (Diffusion |
| Quantum Rod Layer (μm) | Plate) | Plate) | Plate) | Plate) | Plate) | Plate) |
| Total Thickness (μm) | 216 | 216 | 216 | 216 | 216 | 216 |
| Blue Light Selective | — | — | — | — | — | — |
| Reflective Polarizer | | | | | | |
| Green Light and Red Light | — | — | — | — | — | — |
| Selective Reflective Polarizer | | | | | | |
| Total Amount of Light Exiting | 105 | 109 | 108 | 108 | 108 | 111 |
| from Liquid Crystal Panel | | | | | | |
| (Relative Value) | | | | | | |
| Total Amount of Light | 105 | 108 | 110 | 106 | 106 | 107 |
| Exiting from Backlight | | | | | | |
| Unit (Relative Value) | | | | | | |
| | Example 20 | Example 21 | Example 22 | Example 23 | Example 24 | Example 25 |
| | 110 | 110 | 110 | 110 | 110 | 110 |
| | Degrees | Degrees | Degrees | Degrees | Degrees | Degrees |
| | (Apex | (Apex | (Apex | (Apex | (Apex | (Apex |
| | Angle of | Angle of | Angle of | Angle of | Angle of | Angle of |
| | Convex | Convex | Convex | Convex | Convex | Convex |
| | Portion of | Portion of | Portion of | Portion of | Portion of | Portion of |
| | Surface of | Surface of | Surface of | Surface of | Surface of | Surface of |
| | Codensing | Codensing | Codensing | Codensing | Codensing | Codensing |
| | Sheet on | Sheet on | Sheet on | Sheet on | Sheet on | Sheet on |
| | Exiting | Exiting | Exiting | Exiting | Exiting | Exiting |
| | side | side | side | side | side | side |
| | (Surface of | (Surface of | (Surface of | (Surface of | (Surface of | (Surface of |
| | Layer of | Layer of | Layer of | Layer of | Layer of | Layer of |
| | Low | Low | Low | Low | Low | Low |
| Apex Angle of | Refractive | Refractive | Refractive | Refractive | Refractive | Refractive |
| Convex Portion | Index)) | Index)) | Index)) | Index)) | Index)) | Index)) |
| Refractive Index of Layer | 1.35 | 1.20 | 1.35 | 1.35 | 1.35 | 1.35 |
| of Low Refractive Index | | | | | | |
| Depolarization Degree | 0.0010 | 0.0006 | 0.0010 | 0.0010 | 0.0010 | 0.0010 |
| Visible Light Reflect | 60% | 60% | 60% | 60% | 60% | 60% |
| Thickness of Reflective | 26 | 26 | 26 | 26 | 26 | 0 |
| Polarizer (μm) | | | | | | |
| Thickness of Diffusion Plate, | 100 | 100 | 510 | 210 | 210 | 210 |
| Quantum Dot Sheet, or | (Diffusion | (Diffusion | (Quantum | (Quantum | (Quantum | (Quantum |
| Quantum Rod Layer (μm) | Plate) | Plate) | Dot Sheet) | Dot Sheet) | Dot Sheet) | Rod Layer) |
| Total Thickness (μm) | 216 | 216 | 581 | 281 | 281 | 255 |
| Blue Light Selective | — | — | — | Present | Present | Present |
| Reflective Polarizer | | | | | | |
| Green Light and Red Light | — | — | — | | Present | Present |
| Selective Reflective Polarizer | | | | | | |
| Total Amount of Light Exiting | 107 | 111 | 125 | 125 | 129 | 134 |
| from Liquid Crystal Panel | | | | | | |
| (Relative Value) | | | | | | |
| Total Amount of Light | 107 | 107 | 122 | 122 | 127 | 131 |
| Exiting from Backlight | | | | | | |
| Unit (Relative Value) | | | | | | |

(*PET: Polyethylene Terephthalate)

From the results of Table 1 and Table 2, in the liquid crystal display devices of the examples, it is possible to confirm that improvement in luminance is attained, compared to the liquid crystal display devices of the comparative examples.

What is claimed is:

1. A backlight unit, comprising:
a polarized light source unit which is capable of allowing polarized light to exit; and
a condensing sheet which is disposed on the polarized light source unit on an exiting side,
wherein a depolarization degree of the condensing sheet is less than or equal to 0.1500.

2. The backlight unit according to claim 1,
wherein a visible light reflectivity measured on a surface of the condensing sheet on the polarized light source unit side is less than or equal to 70%.

3. The backlight unit according to claim 1,
wherein the polarized light source unit includes at least a light source and a reflective polarizer.

4. The backlight unit according to claim 3,
wherein the polarized light source unit includes a quantum dot-containing layer between the light source and the reflective polarizer.

5. The backlight unit according to claim 4,
wherein the light source is a blue light source, and
the quantum dot-containing layer contains a quantum dot which is excited by exciting light and emits red light arid a quantum dot which is excited by exciting light and emits green light.

6. The backlight unit according to claim 5, further comprising:
a selective reflective layer having a reflective center wavelength in a wavelength range of b e light between the quantum dot-containing layer and the reflective polarizer.

7. The backlight unit according to claim 5, further comprising:
a selective reflective layer having a reflective center wavelength in a wavelength range of green light and in a wavelength range of red light between the light source and the quantum dot-containing layer.

8. The backlight unit according to claim 1,
wherein the polarized light source unit includes at least a light source and a quantum rod-containing layer.

9. The backlight unit according to claim 8, further comprising:
a selective reflective polarizer having a reflective center wavelength in a wavelength range of blue light between the quantum rod-containing layer and the condensing sheet,
wherein the light source is a blue light source, and
the quantum rod-containing layer contains a quantum rod which is excited by exciting light and emits red polarized light and a quantum rod which is excited by exciting light and emits green polarized light.

10. The backlight unit according to claim 9, further comprising:
a selective reflective polarizer having a reflective center wavelength in a wavelength range of green light and in a wavelength range of red light between the light source and the quantumrod-containing layer.

11. The backlight unit according to claim 1,
wherein the condensing sheet includes a plurality of convex portions on a surface on the exiting side.

12. The backlight unit according to claim 11,
wherein a sectional shape of the convex portion is a curved surface shape.

13. The backlight unit according to claim 1,
wherein the condensing sheet is a laminated sheet of two or more layers, and includes a plurality of convex portions protruding to the exiting side on an interface between two layers.

14. The backlight unit according to claim 13,
wherein a sectional shape of the convex portion is a curved surface shape.

15. The backlight unit according to claim 1,
wherein the condensing sheet is a gradient index rod lens array sheet,

16. The backlight unit according to claim 15,
wherein the gradient index rod lens is a cylinder lens.

17. A liquid crystal display device, comprising:
the backlight unit according to claim 1; and
a liquid crystal panel.
